(19) United States
(12) Patent Application Publication
(10) Pub. No.: US 2012/0144067 A1
(43) Pub. Date: Jun. 7, 2012

(54) METHOD FOR ADDING PROVENANCE METADATA TO FILES DOWNLOADED FROM A WEB-BASED SOURCE

(75) Inventor: Robert R. Buckley, Rochester, NY (US)

(73) Assignee: Xerox Corporation, Norwalk, CT (US)

(21) Appl. No.: 12/957,494

(22) Filed: Dec. 1, 2010

(51) Int. Cl. G06F 15/16

(52) U.S. Cl. 709/246

(57) ABSTRACT

A method provides additional information about a file being downloaded from a web-based source. The downloaded file is modified by adding provenance metadata to the downloaded file, the provenance metadata identifying the web-based source of the downloaded file. Upon adding the provenance metadata, the modified downloaded file is stored. The provenance metadata can be read or displayed at a later time to identify the web-based source of the downloaded file.

### BACKGROUND

Conventionally, when a file (an image) is downloaded from a web-based source to a local client; such a personal computer; the information identifying the web-based source is not included in the downloaded file. Thus, a user downloading the file is not able to readily discern, at a later date, the web-based source of the downloaded file, unless either the user keeps a separate record of the web site from where the file was downloaded.

Having information pertaining to the web-based source is useful if the user has to go back, at a later date, to obtain permissions from the copyright owner, obtain other related information from the same web site, or establish a chain of custody for the file, etc.

Therefore, it would be desirable to provide a method or system that automatically adds information to the downloaded file which identifies the web-based source.

Moreover, it would be desirable to provide a method or system that automatically adds provenance metadata to downloaded file which identifies the web-based source.

In addition, it would be desirable to provide a method or system that automatically adds information to the downloaded file which identifies the date on which the file was downloaded.

Furthermore, it would be desirable to provide a method or system that automatically adds information to the downloaded file which identifies who downloaded the file.

### BRIEF DESCRIPTION OF THE DRAWING

The drawings are only for purposes of illustrating various embodiments and are not to be construed as limiting, wherein:

FIG. 1 illustrates a method for adding provenance metadata to a downloaded file which identifies the web-based source;

FIG. 2 illustrates a method for adding information to a downloaded file which identifies the date on which the file was downloaded;

FIG. 3 illustrates a method for adding information to a downloaded file which identifies who downloaded the file; and

FIG. 4 illustrates a system for carrying out the methods illustrated in FIGS. 1-3.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

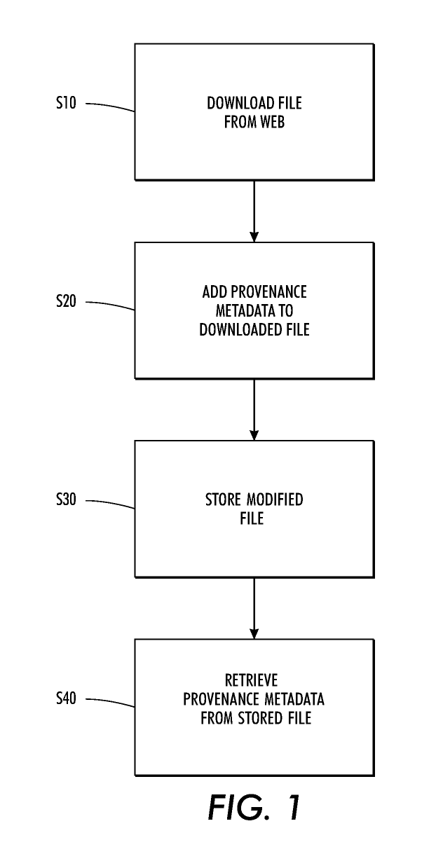

FIG. 1 illustrates, in a flowchart format, a method to add provenance metadata to a downloaded file which identifies the web-based source.

As illustrated in FIG. 1, at step S10, a file is downloaded from a web-based source. The file may be an image, a document, a presentation, or a spreadsheet, etc. At step S20, provenance metadata is added to the downloaded file. The modified file is stored at the local client (personal computer or local server), at step S30. The provenance metadata can be retrieved at a later time when opening the file, at step S40.

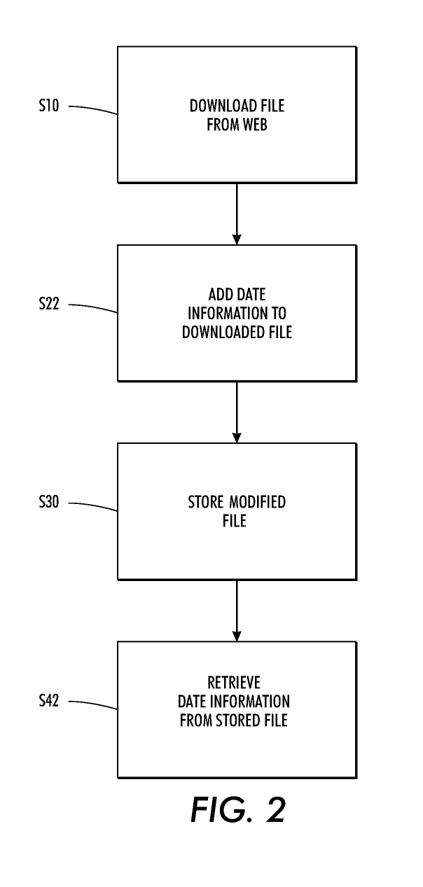

FIG. 2 illustrates, in a flowchart format, a method to add information to a downloaded file which identifies the date on which the file was downloaded.

As illustrated in FIG. 2, at step S10, a file is downloaded from a web-based source. The file may be an image, a document, a presentation, or a spreadsheet, etc. At step S22, information identifying the date on which the file was downloaded is added to the downloaded file. The modified file is stored at the local client (personal computer or local server), at step S30. The date information can be retrieved at a later time when opening the file, at step S42.

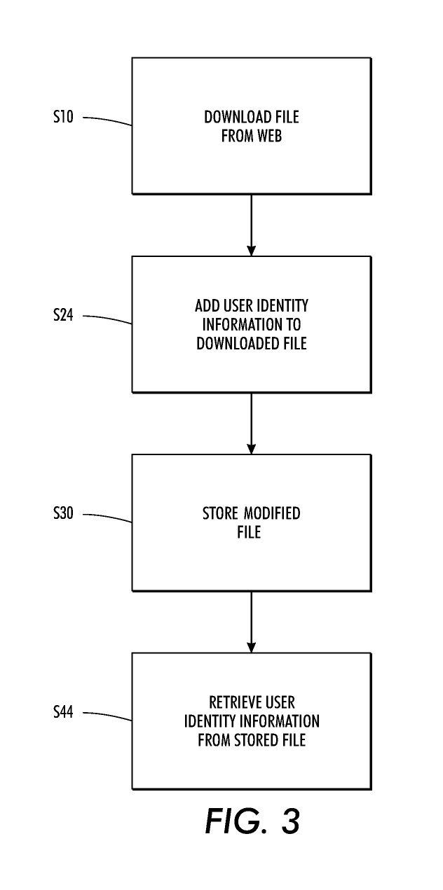

FIG. 3 illustrates, in a flowchart format, a method to add information to a downloaded file which identifies who downloaded the file.

As illustrated in FIG. 3, at step S10, a file is downloaded from a web-based source. The file may be an image, a document, a presentation, or a spreadsheet, etc. At step S24, information identifying who downloaded the file is added to the downloaded file. The modified file is stored at the local client (personal computer or local server), at step S30. The information identifying who downloaded the file can be retrieved at a later time when opening the file, at step S44.

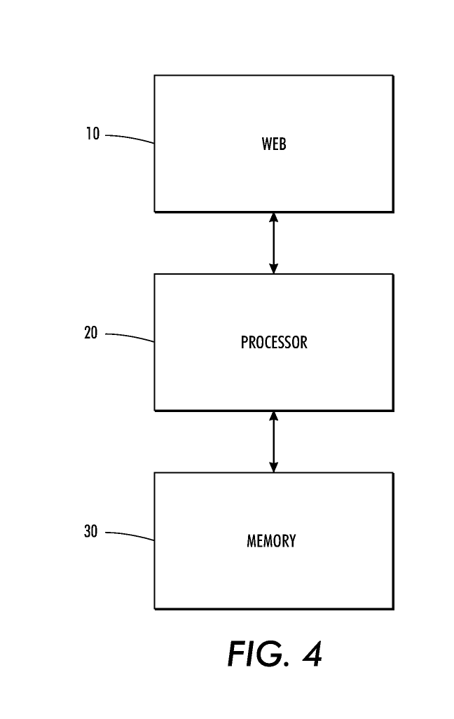

FIG. 4 illustrates a system which executes the methods illustrated in FIGS. 1-3.

As illustrated in FIG. 4, a processor 20 associated a local client (personal computer) is operatively connected to the Web 10 to enable the downloading and uploading of files from and to the Web 10.

The processor 20 receives the downloaded file from a web-based source and may add provenance metadata to the downloaded file. The modified file is stored in a memory device 30 at the local client (personal computer or local server). The processor 20 may also add information identifying the date on which the file was downloaded to the downloaded file. Moreover, the processor 20 may add information identifying who downloaded the file to the downloaded file.

The above-described processes can automatically add linking information to a file when the file is downloaded. For example, the above-described processes could add the uniform resource locator of the web site, from which the file was downloaded, to a marker segment in the file, if the downloaded file is a JPEG file. The contents of the marker segment can be read and displayed as needed with the appropriate tool(s).

The above-described processes can be implemented as a browser plug-in or in a viewer.

Furthermore, if the downloaded file is a JPEG file, an application marker segment containing a string, identifying provenance information, can be added to the JPEG file upon downloading.

In addition, other kinds of information (or metadata) about the provenance of the file can be added to the downloaded file.

For example, the date of the download and who downloaded it can be added as JPEG comment fields if the downloaded file is a JPEG file.

Moreover, for example, the date of the download and who downloaded it can be added as an XMP tag or a “private” tag if the downloaded file is a TIFF file.

Thirdly, for example, the date of the download and who downloaded it can be added as a universally unique identifier or extensible markup language box if the downloaded file is a JPEG2000 file.

Since data is added to the downloaded file, an application based on this process does not perform a copy operation (like “Save Picture As” does), but the process rather modifies the file upon downloading by inserting a new comment, tag, or box in a JPEG, TIFF or JPEG2000 file.

With respect to a JPEG and JPEG2000 File, the process simply requires inserting data without modifying any of the original data.

In the case of a TIFF file, the existing image file directory is updated to accommodate the additional tag(s).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing additional information about a file being downloaded from a web-based source, comprising:
downloading, from a web-based source, a file;
modifying the downloaded file by adding an application marker segment to the downloaded file, the application marker segment including a string identifying the web-based source of the downloaded file; and
storing the modified downloaded file.

2. The method as claimed in claim 1, wherein the string identifying the web-based source of the downloaded file is a uniform resource locator.

3. The method as claimed in claim 1, wherein the string identifying the web-based source of the downloaded file is a uniform resource identifier.

4. The method as claimed in claim 1, wherein the downloaded file is a JPEG file.

5. The method as claimed in claim 4, further comprising:
modifying the downloaded file by adding a comment field to the downloaded file, the comment field including a date on which the file was downloaded from the web-based source.

6. The method as claimed in claim 4, further comprising:
modifying the downloaded file by adding a comment field to the downloaded file, the comment field including information identifying who downloaded the file from the web-based source.

7. The method as claimed in claim 4, further comprising:
modifying the downloaded file by adding a comment field to the downloaded file, the comment field including information identifying who downloaded the file from the web-based source and a date on which the file was downloaded from the web-based source.

8. The method as claimed in claim 1, wherein the downloaded file is a TIFF file.

9. The method as claimed in claim 8, further comprising:
modifying the downloaded file by adding a tag to the downloaded file, the tag including a date on which the file was downloaded from the web-based source.

10. The method as claimed in claim 8, further comprising:
modifying the downloaded file by adding a tag to the downloaded file, the tag including information identifying who downloaded the file from the web-based source.

11. The method as claimed in claim 8, further comprising:
modifying the downloaded file by adding a tag to the downloaded file, the tag including information identifying who downloaded the file from the web-based source and a date on which the file was downloaded from the web-based source.

12. The method as claimed in claim 1, wherein the downloaded file is a JPEG2000 file.

13. The method as claimed in claim 12, further comprising:
modifying the downloaded file by adding a universally unique identifier box to the downloaded file, the universally unique identifier box including a date on which the file was downloaded from the web-based source.

14. The method as claimed in claim 12, further comprising:
modifying the downloaded file by adding a universally unique identifier box to the downloaded file, the universally unique identifier box including information identifying who downloaded the file from the web-based source.

15. The method as claimed in claim 12, further comprising:
modifying the downloaded file by adding a universally unique identifier box to the downloaded file, the universally unique identifier box including information identifying who downloaded the file from the web-based source and a date on which the file was downloaded from the web-based source.

16. The method as claimed in claim 12, further comprising:
modifying the downloaded file by adding an extensible markup language box to the downloaded file, the extensible markup language box including a date on which the file was downloaded from the web-based source.

17. The method as claimed in claim 12, further comprising:
modifying the downloaded file by adding an extensible markup language box to the downloaded file, the extensible markup language box including information identifying who downloaded the file from the web-based source.

18. The method as claimed in claim 12, further comprising:
modifying the downloaded file by adding an extensible markup language box to the downloaded file, the extensible markup language box including information identifying who downloaded the file from the web-based source and a date on which the file was downloaded from the web-based source.

19. A method for providing additional information about a file being downloaded from a web-based source, comprising:
downloading, from a web-based source, a file;
modifying the downloaded file by adding provenance metadata to the downloaded file, the provenance metadata identifying the web-based source of the downloaded file; and
storing the modified downloaded file.

20. The method as claimed in claim 19, further comprising:
retrieving the provenance metadata from the stored modified downloaded file; and
displaying the retrieve provenance metadata.
